(19) United States
(12) Patent Application Publication
(10) Pub. No.: US 2012/0066292 A1
(43) Pub. Date: Mar. 15, 2012

(54) APPARATUS AND METHOD FOR CONTROLLING SERVICE MOBILITY

(75) Inventors: Cho-Rong YU, Daejeon (KR); Jae-Chan SHIM, Daejeon (KR); Hwa-Shin MOON, Daejeon (KR); Hwa-Suk KIM, Daejeon (KR); Sang-Kwon KIM, Daejeon (KR); Kee-Seong CHO, Daejeon (KR)

(73) Assignee: Electronics and Telecommunications Research Institute, Daejeon (KR)

(21) Appl. No.: 12/964,134

(22) Filed: Dec. 9, 2010

(30) Foreign Application Priority Data
Sep. 15, 2010 (KR) 10-2010-0090557

(51) Int. Cl. G06F 15/16

(52) U.S. Cl. 709/203; 709/223

(57) ABSTRACT

Provided are apparatus and method for controlling service mobility. The apparatus includes a subscriber information manager configured to obtain subscriber information from a network core, map the obtained subscriber information with terminals belonging to each subscriber, and store the mapping result, a target terminal information manager configured to obtain information on an available state of terminals available to a subscriber from the obtained subscriber information, a service information manager configured to obtain, maintain, and manage information on available services of a subscriber, information on currently running services, terminal-available service mapping information of each subscriber, currently running terminal-service mapping information, and Service-session mapping information, and a session transfer unit configured to perform a session mobility control procedure for a selected session by incorporating with the network core.

### CROSS-REFERENCE(S) TO RELATED APPLICATIONS

The present application claims priority of Korean Patent Application No. 10-2010-0090557, filed on Sep. 15, 2010, which is incorporated herein by reference in its entirety.

### BACKGROUND OF THE INVENTION

1. Field of the Invention

Exemplary embodiments of the present invention relate to service mobility; and particularly, to an apparatus and method for effectively controlling service mobility through managing service information and session information when a service mobility process is performed between terminals or between networks in a terminal performing at least two services.

2. Description of Related Art

Session mobility is a process of transferring a running session to a target network or to a target terminal if an access network or a terminal is changed during a multimedia service session in progress. Such a process of continuously providing a corresponding service without interruption is referred as service continuity. The service continuity may be achieved by transferring a session without interrupting the session.

The 3^{rd} Generation Partnership Project (3GPP) Release-8 defines multimedia service continuity and guarantees service continuity between access networks. The 3GPP Release-9 defines service continuity between terminals. Lately, the 3GPP Release-10 defines an extended function for guaranteeing service continuity between terminals.

As described above, the 3GPP standards describe a control procedure for session mobility between access networks and between terminals based on a session level. However, there is no standard defined for controlling service mobility at a service level prior to the session mobility control procedure.

For example, a terminal may include a plurality of services. Further, each service may include a plurality of sessions. Accordingly, it is preferentially required to determine which a service is selected from the plurality of services. After selecting the target service, it is also required to determine whether all sessions of the selected service are needed to be transferred or predetermined sessions among all sessions of the selected service are needed to be transferred.

Accordingly, in order to control service mobility based on a service level by expanding the session mobility technology defined in the above described standards, it is required to use information on a plurality of services running in each terminal and information on sessions included in the corresponding service. Therefore, it is required to a method for managing information on a subscriber, a terminal, a plurality of services running in each terminal, and a plurality of sessions included in a corresponding service.

### SUMMARY OF THE INVENTION

An embodiment of the present invention is directed to service mobility control apparatus and method introducing a step-by-step service mobility control procedure that includes two steps: a first step for determining which services are needed to be transferred and a second step for determining whether all sessions of the selected service are needed to be transferred or predetermined sessions thereof are needed to be transferred.

Another embodiment of the present invention is directed to service mobility control apparatus and method for defining a function and a method of managing service and session information in order to effectively control service mobility in a multiservice environment.

Another embodiment of the present invention is directed to service mobility control apparatus and method utilizing functions and methods defined to effective perform a service mobility control procedure in a multiservice environment.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for controlling service mobility of a terminal performing multiservice, includes: a subscriber information manager configured to obtain subscriber information from a network core, map the obtained subscriber information with terminals belonging to each subscriber, and store the mapping result; a target terminal information manager configured to obtain information on an available state of terminals available to a subscriber from the obtained subscriber information; a service information manager configured to obtain, maintain, and manage information on available services of a subscriber, information on currently running services, terminal-available service mapping information of each subscriber, currently running terminal-service mapping information, and Service-session mapping information; and a session transfer unit configured to perform a session mobility control procedure for a selected session by incorporating with the network core.

The subscriber information manager may include: subscriber information obtaining block configured to obtain subscriber information from a subscriber information unit included in the network core; and a subscriber-terminal list configured to map the obtained subscriber information to terminals belonging to a subscriber.

The target terminal information manager may include a terminal information obtaining block configured to obtain information on available terminals to a subscriber and an available state thereof through the obtained subscriber information.

The service information manager may include: an available service list of a corresponding subscriber; a currently running service list; a terminal-available service list storing mapping information on available services of each terminal of a subscriber; a currently running terminal-service list storing mapping information of currently running terminals and services; a service-session list storing information on mapping sessions to each service; a service/terminal information management block configured to obtain, maintain, and manage data of each one of the lists; and a session information management block configured to manage session information.

The subscriber-terminal list may further include a data field for storing a state of a current terminal.

The available service list may further include a performable state field for identifying a state of a service to be currently performable or not when the service is controlled based on a predetermined condition defined in service registration.

The terminal-service list may include a table structure including a data field for storing a terminal identifier, a service identifier, and a current service state.

The service-session list may include a service identifier, a number of sessions of a corresponding service, and session information dynamically created as many as the number of the sessions.

In accordance with another embodiment of the present invention, a terminal for controlling service mobility includes: an available service list configured to include information on available services in the service; a running service list configured to include information on services currently running in the terminal; a session information obtaining block configured to obtain information on sessions of services available in the terminal; a target terminal information obtaining block configured to obtain information on a target terminal for transferring the services or the sessions; a target service/session/terminal information providing block configured to provide information on target service/session/terminal of the terminal to a user interface; and a service mobility block configured to transfer a target service by incorporating with a service mobility control server through a communication network.

In accordance with still another embodiment of the present invention, a method for controlling service mobility in a terminal performing multiservice, includes: selecting a target service to be transferred using subscriber-terminal information obtained through subscriber information of a terminal, executable service information, available terminal information, currently running service information, and service-session information; selecting sessions of the selected service to be transferred; selecting a target terminal to transfer the selected target service and the selected session; and transferring the selected service and the selected session to the selected target terminal.

In accordance with still another embodiment of the present invention, a method for controlling service mobility of a terminal performing multiservice by a service mobility application server, includes: obtaining current information by updating a service list of services running in the terminal; outputting target service information through a user interface of the terminal and waiting for user selection; and outputting available terminal information through a user interface of the terminal when a selection signal for selecting entire services is received from the terminal where the available terminal information is information on terminals capable of performing entire services, selecting a target terminal among the available terminals, and transferring the selected services to the target terminal.

The method may further include: selecting a predetermined service from a target service list when a selection signal for selecting a predetermined service is received from the terminal; obtaining session information of the selected service; outputting session information of the selected service through a user interface of the terminal and waiting for user selection; and outputting available terminal information through a user interface of the terminal when a session selection signal for selecting entire sessions of the selected service is received from the terminal where the available terminal information is information on terminals capable of performing sessions of the selected service, selecting a target terminal among the available terminals, and transfers the entire sessions to the target terminal.

The method may further include: selecting a predetermined session from a target session list when a selection signal for selecting the predetermined selection of the selected service from the terminal; and outputting the available terminal information through a user interface of the terminal where the available terminal information is information on available terminals capable of performing the selected session, selecting a target terminal among the available terminals, and transferring the selected session to the target terminal.

In the outputting the available terminal information, the available terminal information may be dynamically reconfigured in consideration of capability of terminals capable of outputting a corresponding media according to media information included in a session when each session is transferred, and the reconfigured available terminal information is provided to a user.

### BRIEF DESCRIPTION OF THE DRAWINGS

FIG. 1 is a diagram illustrating service mobility between terminals according to a service mobility control method in accordance with an embodiment of the present invention.

FIG. 2 is a block diagram illustrating a service mobility control apparatus performing a service mobility control method in accordance with an embodiment of the present invention.

FIG. 3 is a diagram illustrating a subscriber-terminal list table for storing information on terminals of a subscriber and subscriber information.

FIG. 4 is a diagram illustrating a service list table for storing available services of each subscriber.

FIG. 5 is a diagram illustrating a terminal-service list table for storing a list of services performable in a terminal per each terminal of a subscriber.

FIG. 6 is a diagram illustrating a service-session list table for storing information on sessions of each service.

FIG. 7 is a flowchart illustrating a method for controlling service mobility between terminals in accordance with an embodiment of the present invention.

FIG. 8 is a flowchart illustrating a method for controlling service mobility in accordance with an embodiment of the present invention.

### DESCRIPTION OF SPECIFIC EMBODIMENTS

As described above, it is required to provide a step-by-step service mobility control procedure in a multiservice environment. That is, it is preferentially required to determine which services are needed to be transferred from the plurality of services. After selecting the target services, it is also required to determine whether all sessions of the selected service are needed to be transferred or predetermined sessions among all sessions of the selected service are needed to be transferred. For the step-by-step service mobility control procedure, it is required to define a function of managing information on a user, a terminal, services, and sessions in a user terminal and a service mobility application server having a service mobility function.

Accordingly, a service mobility control apparatus and method in accordance with an embodiment of the present invention defines a function and a method for managing service and session information in order to effective perform a service mobility control process in a multiservice environment.

Exemplary embodiments of the present invention will be described below in more detail with reference to the accompanying drawings.

The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention. The drawings are not necessarily to scale and in some instances, proportions may have been exaggerated in order to clearly illustrate features of the embodiments.

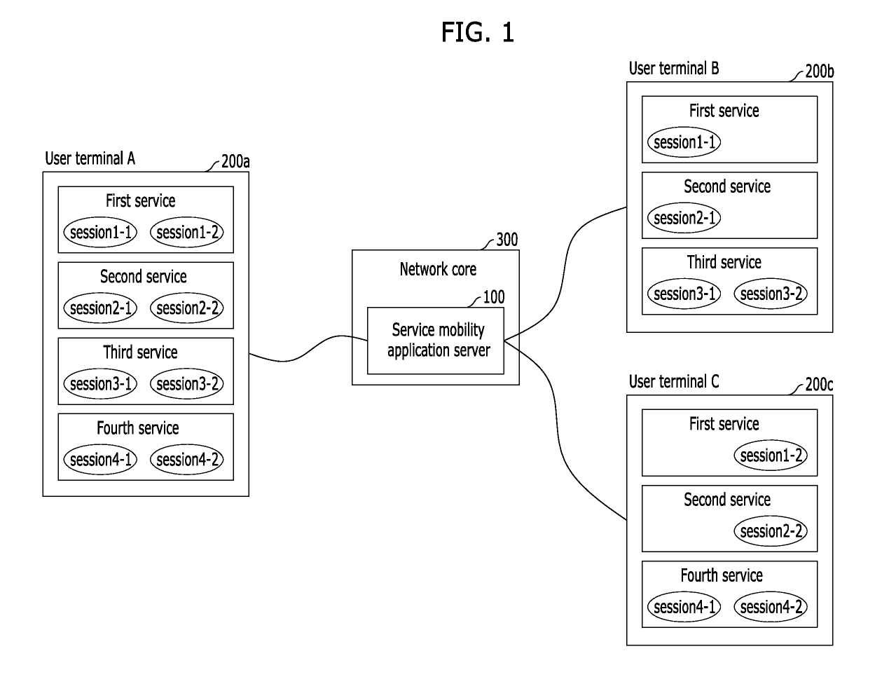

FIG. 1 is a diagram illustrating service mobility between terminals based on a service mobility control method in accordance with an embodiment of the present invention. FIG. 1 illustrates sessions and services separated from each other and transferred when a service includes a plurality of sessions.

Referring to FIG. 1, a plurality of services performed in a first user terminal 200A are transferred to a second user terminal 200B or a third user terminal 200C through a network core 300 in response to control of a service mobility application server 100. Here, all sessions or some predetermined sessions in each service may be transferred to a target terminal.

As shown in FIG. 1, when a service is transferred from one terminal having a plurality of services to the other, a predetermined one of the services may be selected and transferred. Alternately, entire services may be transferred. In order to effectively manage transferring such services, a service mobility control method is required in consideration of both of sessions and services.

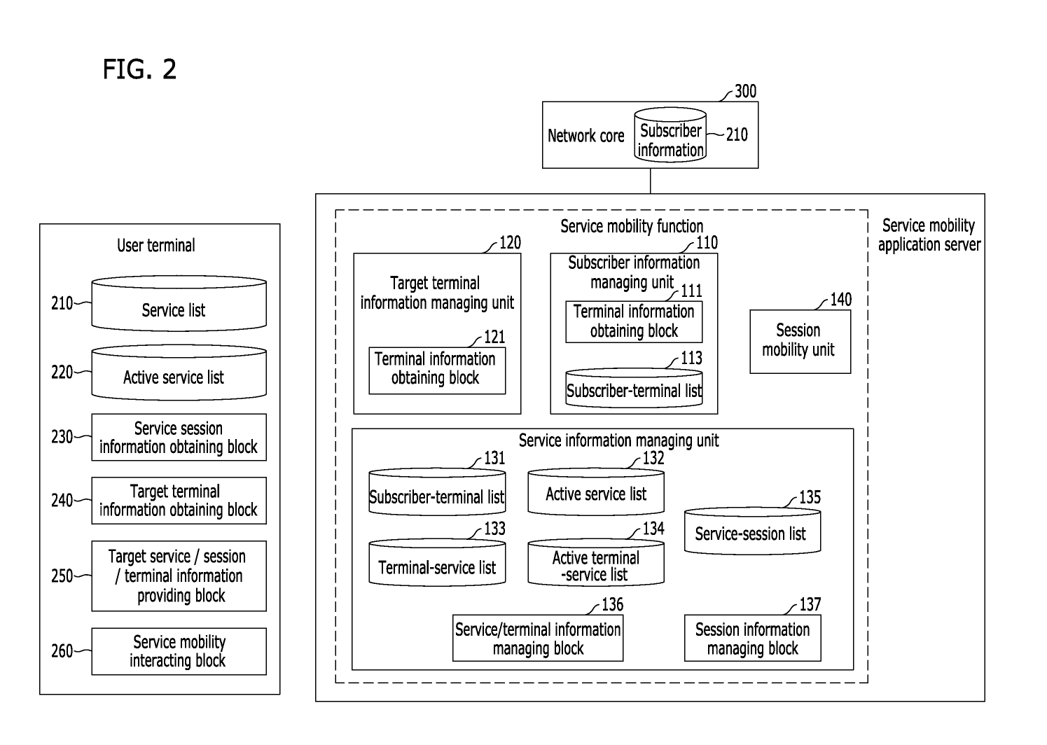

FIG. 2 is a block diagram illustrating a service mobility control apparatus performing a service mobility control method in accordance with an embodiment of the present invention. FIG. 2 illustrates a service mobility application server 100 including a service mobility module 101 and a user terminal 200 including service mobility related modules.

Referring to FIG. 2, the service mobility module 101 of the service mobility application server 100 includes a subscriber information manager 110, a target terminal information manager 120, a service information manager 130, and a session mobility unit 140.

The subscriber information manager 110 includes a subscriber information obtaining block 111 and a subscriber-terminal list 113. The subscriber information obtaining block 111 obtains subscriber information from a subscriber information unit 310 included in the network core 300. The subscriber-terminal list 113 maps the obtained subscriber information to terminal information on terminals belonging to each subscriber and stores the mapping result. The subscriber information obtaining block 111 is required to have information on an available state of a terminal. Accordingly, a user inputs the available state of the terminal by checking whether the terminal has a function for transferring a selected target service.

A user may determine whether a terminal is capable of transferring a selected service or not based on subscriber terminal information and terminal profile information included in the network core 300. In order to select a service mobility capable terminal through the obtained information, the service mobility target terminal information includes the available state information which is dynamically changed. Further, a user may use such information.

The subscriber-terminal list 113 is used later to map a terminal to a list of available services of each subscriber. The target terminal information manager 120 includes a terminal information obtaining block 121. The terminal information obtaining block 121 obtains information on available terminals and an available state thereof through the obtained subscriber information.

The service information manager 130 includes an available service list 131 of a corresponding subscriber, an active service list 132, a terminal-service list 133, an active terminal-service list 134, a service-session list 135, a service/terminal information managing block 136, and a session information managing block 137. The active service list 132 is a list of currently running services. The terminal-service list 133 is a list storing information on mapping available services to each terminal. The active terminal-service list 134 is a list storing information on currently running terminals to services. The service-session list 135 is a list storing information on mapping sessions to corresponding service. The service/terminal information managing block 135 and the session information managing block 137 obtain, maintain, and manage the above lists.

In order to obtain information on services and sessions currently running in a terminal, information on a service setup procedure may be obtained through the network core 300. Then, each data list may be updated based on the obtained information. The session transfer unit 140 carries out a mobility control procedure for a selected session. The session transfer unit 140 performs the session mobility control procedure for selected session in interacting with the network core 300.

The user terminal 200 includes a service list 210, an active service list 220, a service session information obtaining block 230, a target terminal information obtaining block 240, a target service/session/terminal information providing block 250, and a service mobility interacting block 260.

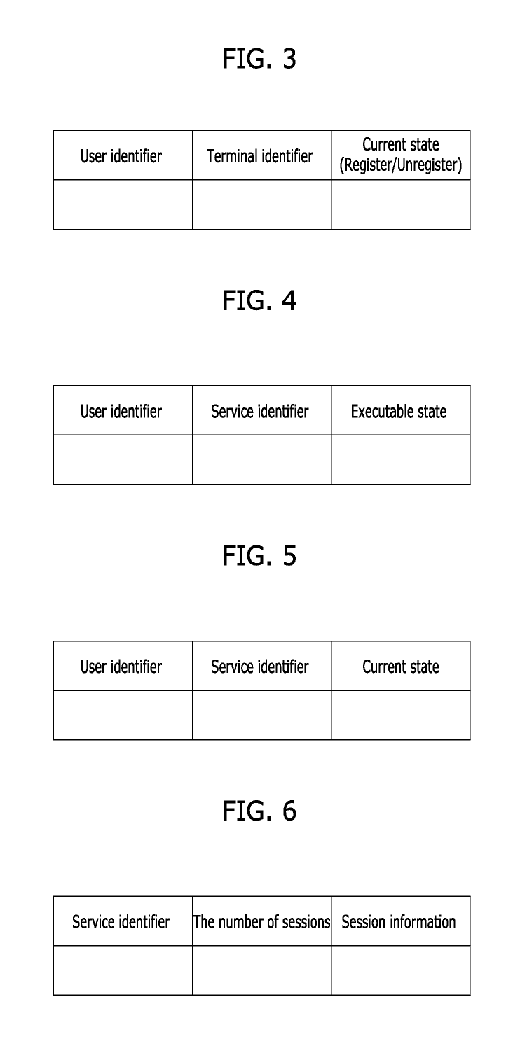

FIGS. 3 to 6 are diagrams illustrating a table structure of new lists used in a service mobility control apparatus and method in accordance with an embodiment of the present invention.

FIG. 3 illustrates a subscriber-terminal list table for storing information on a subscriber and terminals thereof. The subscriber-terminal list additionally includes a data field for storing a current state of a terminal. In case of an IP multimedia subsystem (IMS) subscribing terminal, the subscriber-terminal list table may include information on a state of a terminal, for example, as Register or Unregister.

FIG. 4 illustrates a service list table for storing information on available services of each subscriber. The service list table additionally includes an executable service field for identifying a state of a currently executable service

FIG. 5 illustrates a terminal-service list table storing a list of executable services in a terminal for terminals of a subscriber. As shown, the terminal-service list table includes data fields for storing a terminal identifier, a service identifier, and a current service station.

FIG. 6 illustrates a service-session list table for storing information on sessions of each service. The service-session list table includes data fields for a service identifier, the number of sessions of a corresponding service, and session information which are dynamically generated as many as the number of sessions. The session information may include a media type of a session, transferred session information, received session information, and media information.

Meanwhile, it is required to synchronize a service list 210 with a running service list 220 in a user terminal 200 through interacting with a service mobility application server 100. The service session information obtaining block 230 may obtain session information of a corresponding service from a table of the service-session information unit 135.

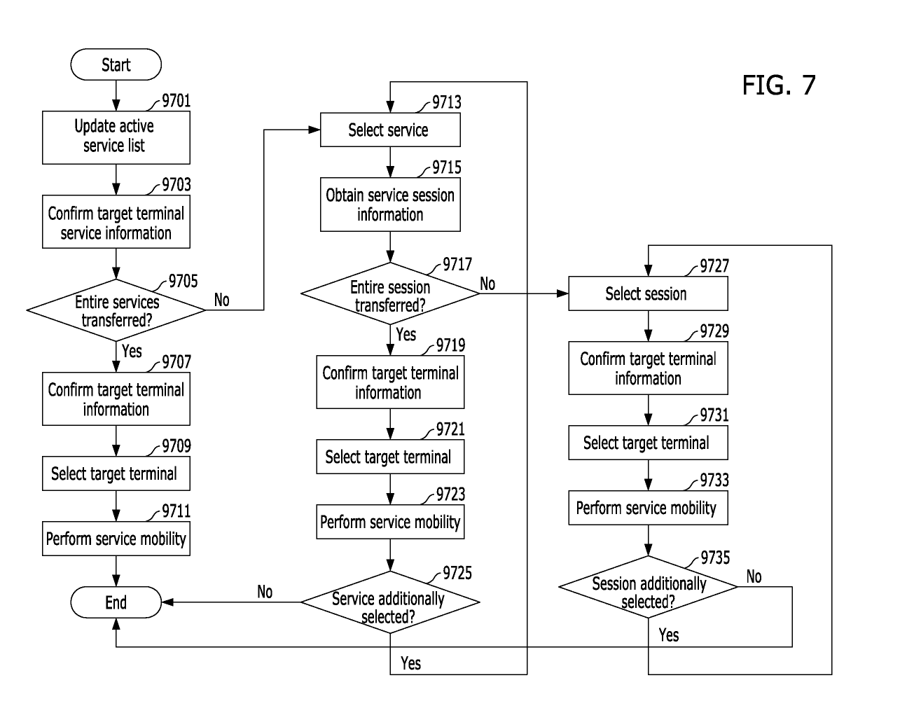

FIG. 7 is a flowchart illustrating a method for controlling service mobility between terminals in accordance with an embodiment of the present invention. The flowchart of FIG. 7 illustrates an operation of a server 100 that control service mobility between terminals when a terminal includes a plurality of services.

Referring to FIG. 7, a server 100 obtains the most recent information by updating a running service list in a terminal in a process P701. In a process P703, the server 100 outputs target service information to a user through a user interface of the user terminal 200. In a process P705, the server 100 requests a user to select whether all services to be transferred or a predetermined service to be transferred.

When the user selects all services to be transferred in the process P705, the server outputs information on all target terminals capable of performing all services in a process P707. A user selects a target terminal among the available terminals in a process P709 and the server performs service mobility through corresponding information in a process P711.

On the contrary, when the user selects a predetermined service to be transferred in the process P705, a predetermined service is selected from a mobility target service list in a process P713, service session information of a corresponding service is obtained in a process P715, and the server requests a user to determine whether to select predetermined sessions or all sessions of the corresponding service in a process P717. According to the selection of the P717, the user may transfer all sessions or predetermined sessions of the corresponding service to a target terminal.

When the user selects the all sessions in the process P717, a terminal capable of performing all sessions is confirmed in a process P719. In a process P721, a target terminal is selected among available terminals. In a process P723, a selected session is transferred through corresponding information.

When the user selects transferring a predetermined session of the service in the process P717, a corresponding selection is selected from a session list of a target service in a process P727, a terminal capable of performing the selection session is confirmed in a process P729, and a target terminal is selected from the available terminals in a process P731, and service mobility is carried out through corresponding information in a process P735.

In the service mobility control method in accordance with an embodiment of the present invention, the same process is repeatedly performed for a plurality of services and sessions to perform a mobility control procedure for a plurality of services and sessions. The target terminal information is dynamically reconfigured in consideration of terminals' capability of outputting a corresponding media according to media information in a session when each session is transferred. Such updated target terminal information is provided to a user.

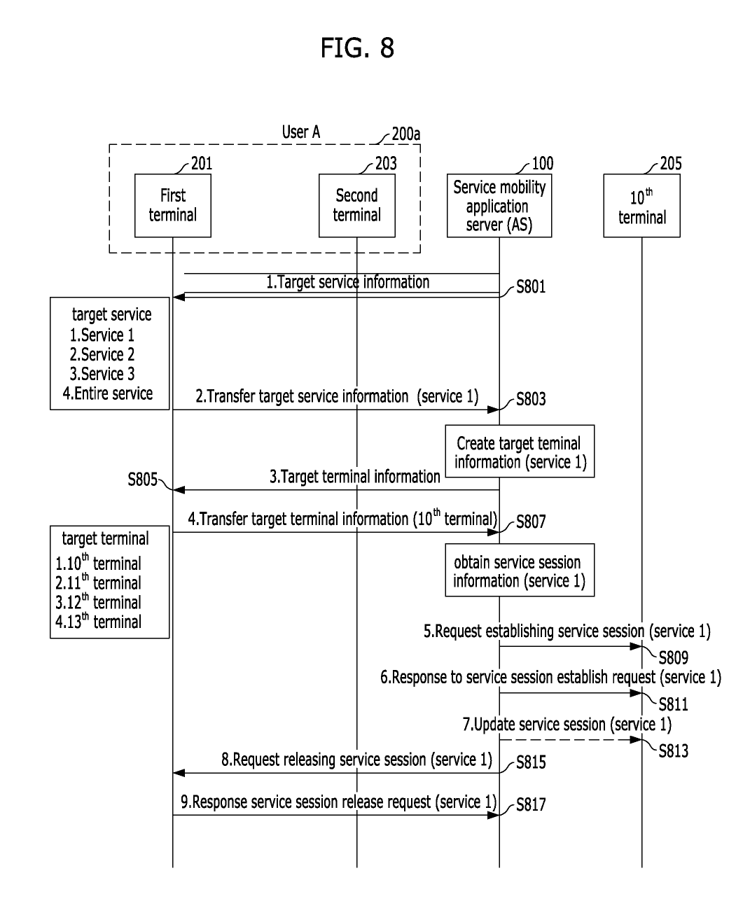

FIG. 8 is a flowchart illustrating a method for controlling service mobility in accordance with an embodiment of the present invention. The flowchart of FIG. 8 illustrates transferring one of a plurality of services used in a user terminal to other user terminal. For example, a user A using a plurality of services transfers a first service of a first terminal 201 to a 10^{th} terminal 205.

Referring to FIG. 8, the first terminal 201 obtains information on a target terminal and a target service from a service mobility application server 100 at step S801. The first terminal 201 outputs a list of target services through a user interface based on the obtained information and requests a user to select (See P701 to P705 of FIG. 7).

Accordingly, the user selects a first service, and the first terminal 201 transmits information on the first service to the service mobility application server 100 at step S803. The service mobility application server 100 receives the first service information from the first terminal 201, creates information on available target terminals that are capable of performing the first service according to the transmitted information from the first terminal, and transmits the created information to the first terminal at step S805. The first terminal 201 outputs the received available terminal information to the user through a user interface and requests the user to select one of the terminals (See P713 to P719 of FIG. 7).

When the user selects the 10^{th} terminal 205 as a target terminal, the first terminal 201 transmits information on the 10^{th} terminal 205 to the service mobility application server 100 at step S807.

The service mobility application server 100 receiving the information on the first service from the first terminal 201 obtains information on sessions corresponding to the first service according to the transmitted information from the first terminal 201 and requests the terminal 205 to establish a service session for the first service 1 at step S809. At step S811, the service mobility application server 100 receives a response to the service session establish request for the first service from the 10^{th} terminal 205. At step S813, a service session update is performed between the service mobility application server 100 and the 10^{th} terminal 205.

All sessions of the first service are transferred from the first terminal 201 to the 10^{th} terminal 205 through the service session update between the service mobility application server 100 and the 10^{th} terminal 205. By a service session release request at step S815 and a response thereof at step S817 between the service mobility application server 100 and the first terminal 201, the first service and the sessions thereof are completely transferred.

In order to effectively manage and control transferring services and sessions in a multiservice environment, it is required to provide a step-by-step service mobility control procedure as described above which includes two steps: a first step for determining which services are needed to be transferred and a second step for determining whether all sessions of the selected service are needed to be transferred or predetermined sessions thereof are needed to be transferred.

In order to provide such a step-by-step service mobility control procedure, it is required to define a function of managing information about a subscriber, a terminal, services, and sessions at a user terminal and a service mobility application server having a service mobility function. In an embodiment of the present invention, a service and session information management procedure is defined, and a service mobility control apparatus and method are provided in order to effectively control service mobility in a multiservice environment.

The service mobility control apparatus and method in accordance with an embodiment of the present invention may provide a user interface to select a predetermined service among target services when a predetermined service is selected and transferred to other terminal or other access network in a terminal performs a plurality of services.

Further, the service mobility control apparatus and method in accordance with an embodiment of the present invention provides an interface to a terminal for determining whether all sessions of a service are transferred or predetermined sessions are selected and transferred to a plurality of terminals by obtaining session information in a corresponding service when a target service is selected.

A service or sessions thereof may be transferred by transferring information on a service selected by a user through the interface or by transferring information on sessions of a corresponding service to a service mobility application server.

Particularly, the service mobility control apparatus and method in accordance with an embodiment of the present invention provides a mobility control procedure for controlling a service mobility process not only per each service but also per each session. Accordingly, a use is enabled to effectively select a target session and a target service in a multiservice environment when a user wants to transfer a service or a session.

As described above, the service mobility control apparatus and method in accordance with an embodiment of the present invention provide a user interface to a user for selecting a predetermined service among target services when a predetermined service is selected and transferred to other terminal or other access network in an environment whether a plurality of services are running in a terminal. The service mobility control apparatus and method in accordance with an embodiment of the present invention also provides a user interface to a terminal to determine whether to transfer all sessions or predetermined sessions to a plurality of terminals by obtaining session information on sessions included in the selected service.

Accordingly, the service mobility control apparatus and method in accordance with an embodiment of the present invention transfer a service selected through a user interface provided to a terminal and sessions of the selected service by transferring information on the selected service and sessions thereof to the service mobility application server. Accordingly, the service mobility control apparatus and method in accordance with an embodiment of the present invention control a service mobility process per each service in an environment whether a plurality of services are running.

The service mobility control apparatus and method in accordance with an embodiment of the present invention enables a user to effective select a target session and a target service when a user wants to transfer a service or a session by providing a step-by-step mobility control process per each session. Accordingly, the efficiency of service mobility is improved.

While the present invention has been described with respect to the specific embodiments, it will be apparent to those skilled in the art that various changes and modifications may be made without departing from the spirit and scope of the invention as defined in the following claims.

What is claimed is:

1. An apparatus for controlling service mobility of a terminal performing multiservice, comprising:
a subscriber information manager configured to obtain subscriber information from a network core, map the obtained subscriber information with terminals belonging to each subscriber, and store the mapping result;
a target terminal information manager configured to obtain information on an available state of terminals available to a subscriber from the obtained subscriber information;
a service information manager configured to obtain, maintain, and manage information on available services of a subscriber, information on currently running services, terminal-available service mapping information of each subscriber, currently running terminal-service mapping information, and Service-session mapping information; and
a session transfer unit configured to perform a session mobility control procedure for a selected session by incorporating with the network core.

2. The apparatus of claim 1, wherein the subscriber information manager includes:
a subscriber information obtaining block configured to obtain subscriber information from a subscriber information unit included in the network core; and
a subscriber-terminal list configured to map the obtained subscriber information to terminals belonging to a subscriber.

3. The apparatus of claim 1, wherein the target terminal information manager includes a terminal information obtaining block configured to obtain information on available terminals to a subscriber and an available state thereof through the obtained subscriber information.

4. The apparatus of claim 1, wherein the service information manager includes:
an available service list of a corresponding subscriber;
a currently running service list;
a terminal-available service list storing mapping information on available services of each terminal of a subscriber;
a currently running terminal-service list storing mapping information of currently running terminals and services;
a service-session list storing information on mapping sessions to each service;
a service/terminal information management block configured to obtain, maintain, and manage data of each one of the lists; and
a session information management block configured to manage session information.

5. The apparatus of claim 2, wherein the subscriber-terminal list further includes a data field for storing a state of a current terminal.

6. The apparatus of claim 4, wherein the available service list further includes a performable state field for identifying a state of a service to be currently performable or not when the service is controlled based on a predetermined condition defined in service registration.

7. The apparatus of claim 4, wherein the terminal-service list includes a table structure including a data field for storing a terminal identifier, a service identifier, and a current service state.

8. The apparatus of claim 4, wherein the service-session list includes a service identifier, a number of sessions of a corresponding service, and session information dynamically created as many as the number of the sessions.

9. A terminal for controlling service mobility, comprising:
an available service list configured to include information on available services in the service;
a running service list configured to include information on services currently running in the terminal;
a session information obtaining block configured to obtain information on sessions of services available in the terminal;
a target terminal information obtaining block configured to obtain information on a target terminal for transferring the services or the sessions;
a target service/session/terminal information providing block configured to provide information on target service/session/terminal of the terminal to a user interface; and
a service mobility block configured to transfer a target service by incorporating with a service mobility control server through a communication network.

10. A method for controlling service mobility in a terminal performing multiservice, comprising:
selecting a target service to be transferred using subscriber-terminal information obtained through subscriber information of a terminal, executable service information, available terminal information, currently running service information, and service-session information;
selecting sessions of the selected service to be transferred;
selecting a target terminal to transfer the selected target service and the selected session; and
transferring the selected service and the selected session to the selected target terminal.

11. A method for controlling service mobility of a terminal performing multiservice by a service mobility application server, comprising:
obtaining current information by updating a service list of services running in the terminal;
outputting target service information through a user interface of the terminal and waiting for user selection; and
outputting available terminal information through a user interface of the terminal when a selection signal for selecting entire services is received from the terminal where the available terminal information is information on terminals capable of performing entire services, selecting a target terminal among the available terminals, and transferring the selected services to the target terminal.

12. The method of claim 11, further comprising:
selecting a predetermined service from a target service list when a selection signal for selecting a predetermined service is received from the terminal;
obtaining session information of the selected service;
outputting session information of the selected service through a user interface of the terminal and waiting for user selection; and
outputting available terminal information through a user interface of the terminal when a session selection signal for selecting entire sessions of the selected service is received from the terminal where the available terminal information is information on terminals capable of performing sessions of the selected service, selecting a target terminal among the available terminals, and transfers the entire sessions to the target terminal.

13. The method of claim 12, further comprising:
selecting a predetermined session from a target session list when a selection signal for selecting the predetermined selection of the selected service from the terminal; and
outputting the available terminal information through a user interface of the terminal where the available terminal information is information on available terminals capable of performing the selected session, selecting a target terminal among the available terminals, and transferring the selected session to the target terminal.

14. The method of claim 13, wherein in the outputting the available terminal information,
the available terminal information is dynamically reconfigured in consideration of capability of terminals capable of outputting a corresponding media according to media information included in a session when each session is transferred, and the reconfigured available terminal information is provided to a user.
